(19) United States
(12) Patent Application Publication
(10) Pub. No.: US 2014/0375833 A1
(43) Pub. Date: Dec. 25, 2014

(54) Remote Control Attachment For Image Capturing Equipment

(71) Applicant: Paul Stephen Marshall, Mayport, PA (US)

(72) Inventor: Paul Stephen Marshall, Mayport, PA (US)

(21) Appl. No.: 13/927,058

(22) Filed: Jun. 25, 2013

(51) Int. Cl. H04N 5/232

(52) U.S. Cl. CPC H04N 5/23203
USPC 348/211.4

(57) ABSTRACT

Disclosed herein is a device that may be attached to image capturing equipment. It will act upon the existing manual shutter release means, allowing images to be captured by radio remote control. It will not permanently change the form, fit, or function of said equipment. Normal manual operation of the equipment will still be possible with the invention attached as disclosed. Using remote control, the device will apply programmable forces to existing shutter release means such that the equipment can set photo-metric data and capture images.

Its primary purpose is to effectively perform the functions of the finger of the operator such that an operator wishing to capture an image can be distant from the photographic equipment whilst doing so.

### BACKGROUND TO THE INVENTION

As well as the limitation of not being able to effectively capture one's own image without assistance this device overcomes several other problems with manually operated image capturing equipment, the following are three examples;

There is often a desire to be able to capture an image whilst the operator is engaged in an activity, for instance whilst hunting.

There are advantages and equipment cost savings when photographing wildlife if the equipment can be placed dose to the subject whilst the operator is some distance from it.

If a camera is mounted on a spotting scope (called digi-scoping), manually depressing the shutter release causes shaking of the equipment resulting in poor image quality. To overcome this problem very expensive equipment is usually necessary. This invention allows standard low cost equipment to be effective, since it nearly eliminates the shaking.

The primary purpose of this invention is to apply, to the shutter release means of image capturing equipment, the force required to operate the shutter release and capture an image while the person wishing to capture the image (the operator) is physically remote from the equipment. The secondary aim is to do this in such a way that the invention may be attached to and detached from a very wide range of image capturing equipment without the need to modify said equipment, without any direct connection to the equipment electronics and without causing damage to the equipment. This has been achieved by simulating the pressure of a finger. It was devised originally to be used with compact digital cameras but the invention can also be used to operate cell (mobile) phone cameras, digital SLR cameras, video cameras and other equipment requiring controllable force to be applied to a button while the operator is remote from the equipment.

### BRIEF DESCRIPTION OF THE FIGURES

FIG. 1: shows how an embodiment of the invention may be attached to a compact digital camera.

FIG. 2: shows the functional Block Diagram for the control and power electronics FIGS. 3A & 3B: show the points of note of the attachment enclosure

FIGS. 4A to 4E inclusive: show the actuator assembly in detail and cross section.

FIGS. 5A & 5B: show the embodiment of the invention as used with a touch screen mobile telephone.

### DETAILED DESCRIPTION OF THE PRESENT EMBODIMENTS

### Embodiment 1

This embodiment will consist of two parts, a key fob style 4 button remote controller carried by the operator and an attachment part that is fitted to the image capturing equipment.

### Remote Controller

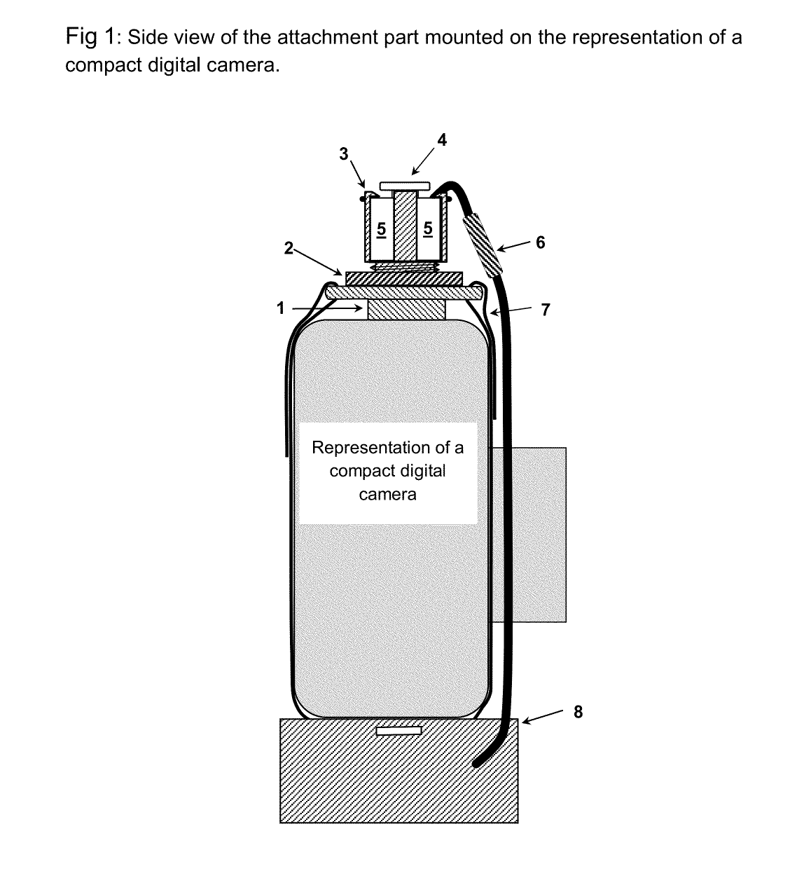

The four button, key fob type remote controller will command the attachment part, shown in FIG. 1, to perform the required functions using radio frequency communications and appropriate instruction coding.

Four button remote controller enclosures are readily available and exist in many forms; the design of this part and the design of the radio frequency communication transmitter and receiver are therefore to be left to those skilled in the art such that a low cost, commercially available remote controller may be employed.

Functions programmed to the remote controller buttons.

There are three distinct modes in which the remote controller may be employed; commissioning the attachment part, programming the attachment part to operate a particular piece of image capturing equipment and normal use. Programming the attachment part is described in the section describing the operation of that part.

### Commissioning

Any Button pressed while the attachment part is in commissioning mode will program the attachment part with the remote controller identifying code. The attachment part will confirm by a single flash of its LED. Commissioning restricts the attachment part to communicate only with a remote controller which transmits the commissioned identifying code.

### Normal Use

Button 1 press—if required the image capturing equipment can collect photo-metric data when 1 is pressed. The force applied by the actuator will partially depress the shutter release means. This force will be maintained for up to two seconds without the need to maintain pressure on button 1. Focus force will be released automatically when either button 2 is pressed or Button 1 is pressed again (within two seconds of the first press) or after two seconds have elapsed.

Button 2 press—the shutter release means of the image capturing equipment will be fully depressed and an image captured. Force is maintained on the shutter release means if button 2 remains pressed up to a maximum of three seconds. This functionality allows for sequential capture of multiple images (if the image capturing equipment has this capability).

Button 3 press—Sets the attachment part into “Stay Awake” mode. As its name suggests “Stay Awake” prevents the image capturing equipment entering sleep mode. The next press of button 3 will cancel “Stay Awake” mode i.e. this button toggles “Stay Awake”. During “Stay Awake” the actuator will periodically apply focus force for a quarter second.

Button 4 press—this button allows the “Stay Awake” time interval to be selected from a set of pre-set time intervals. Each press of button 4 will scroll through the available options. The enclosure LED will flash a corresponding number of times to indicate which interval is active.

### The Attachment Part

FIG. 1 shows the attachment part mounted on the representation of a compact digital camera. The attachment part consists of a flexible conductor and connector 6, attachment means 7, control enclosure 8 and actuator assembly 1 to 5.

The attachment means, 7, is an expandable strap designed to be non-slip, it will have hook and loop fastening at both ends. The attachment means will pass through the wall of the control enclosure near one end. In this way the enclosure will form a stable base onto which the image capturing equipment can be secured by the attachment means. If the image capturing equipment is mounted on another piece of equipment, a tripod for example, the attachment means can pass through one end wall of the enclosure thus supporting the enclosure and allowing easy connection to the actuator assembly.

The attachment part control enclosure 8 will be cuboid and sized so as to be able to enclose the necessary electronic assemblies, a 9V, PP3 battery and the necessary power and control interfaces. The present embodiment is shown in FIGS. 3A & 3B. Externally, integrated into the enclosure there will be; a flexible conducting element to transfer power to the actuator, 6. An LED to signal the status of the internal control & communication electronics, 12. A power connector for external power 13. An ON/OFF switch, 14 and a means to reset the micro-controller, 15.

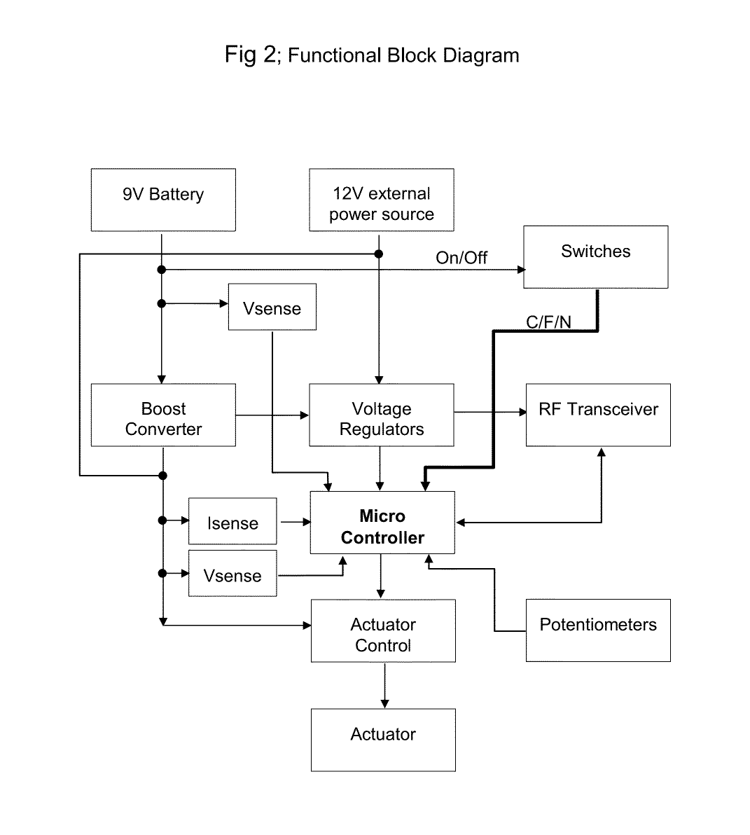

Internal to the attachment enclosure there will be power conditioning circuits, an RF transceiver circuit, a micro-controller circuit, a power control circuit, a 3 position mode switch and a force adjusting potentiometer. FIG. 2 shows the block diagram of the power and control circuits. The boost converter will provide a stable actuator voltage of 11.8V from a battery voltage of 5V to 12V.

RF transceiver circuit—the function of this circuit is to receive instructions from the remote controller part and pass them to the micro-controller. The design of this part is to be left to those skilled in the art since it will depend on the design of the remote controller transmitter.

Micro-controller Circuit—The micro-controller will process instructions from the remote controller and output the appropriate signals to the actuator control circuit. These actuator control signals include but may not be limited to;

i. Apply focus force for two seconds or until the capture force instruction is received. Current and voltage information to achieve focus force will be stored in micro-controller memory. A micro-controller PWM output will be used to drive a logic level power switching device. If the focus button is depressed again during the two seconds the focus command is immediately cancelled. During application of focus force the micro-controller will also output an instruction to illuminate the LED on the control enclosure. The micro-controller will if necessary compensate for changes in battery condition etc. by control of appropriate circuits and/or PWM duty cycle to ensure a consistent focus force is maintained. It will do this until battery condition falls to a critical level. The LED will indicate low battery prior to the battery reaching to critical capacity.

ii. Apply image capture force while button 2 of the remote controller is depressed, up to a three second period of time; by applying a force (that exceeds focus force) to the shutter release means. A rapid press and release of button 2 will apply image capture force for a half second. Application of capture force will be indicated by the LED illumination. If button 1 has been pressed capture force will not be applied until approximately one second after focus force was initially applied to ensure photo-metric data is set. To immediately capture an image, capture force can be applied via button 2; there will be no requirement to first apply focus force via button 1 and no delay in applying capture force in this case

iii. Periodically apply focus force to achieve “Stay awake”. The period will be set by the operator. Application of focus force will be a quarter second or less, the control enclosure LED will flash twice at each application of force to indicate stay awake is active. The “Stay Awake” function is designed to keep the image capturing equipment active and ready to immediately capture an image. This function is provided for the following reason: When image capturing equipment goes from active mode to sleep mode the operator is often required to press the on/off button to bring the equipment back into active mode. This embodiment is not capable of pressing the separate on/off button and “Stay Awake” avoids the need for operator intervention.

Additionally and with the provision of a three position PCB mounted switch (accessible via a battery compartment cover), the following functions will be realised by the micro-controller circuit.

Switch position 1—“N”=Normal use.

Position 2—“C”=Commissioning mode. In this mode the identifying code of the remote controller is loaded into non-volatile memory when any button on the remote controller is pressed. In this way only a remote controller transmitting the same code can control the attachment part.

Position 3—“F”=set force mode. Whilst the switch is in this position the operator will adjust a potentiometer until focus force is applied to the shutter release means. When the image capturing equipment indicates it is collecting photometric data the operator will press the focus button (button 1 on the remote controller) to set and store PWM duty cycle, voltage and current information which results in correct focus force. By continuing to adjust the potentiometer and using button 2 on the remote controller, optimum force to achieve image capture can be set in the same way. This function is included so that battery life can be optimised. Depending on which button is pressed the micro-controller will respond in the appropriate way whilst the switch is in position “F”. PWM duty cycle, voltage and current information for each level of force will be stored by the micro-controller such that a consistent focus and capture force can be maintained. Letters to indicate switch position and function will be included in the PCB silkscreen as will indicators for the function of the potentiometer.

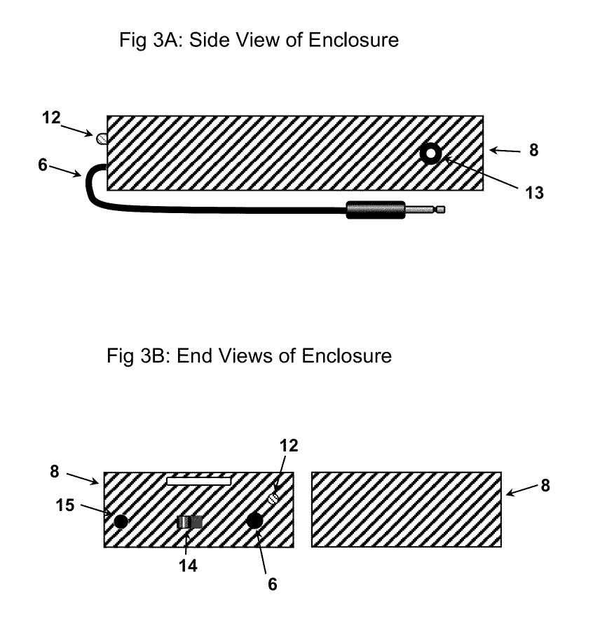

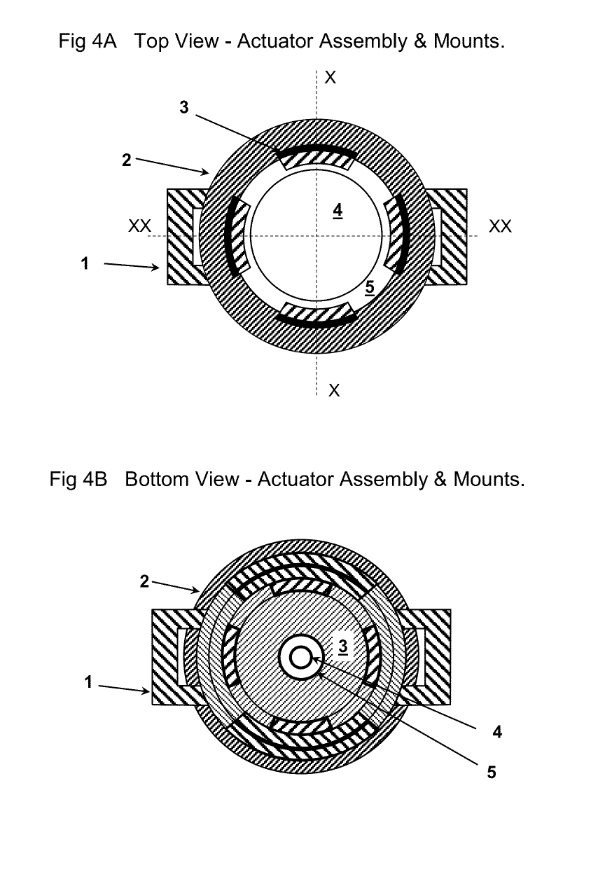

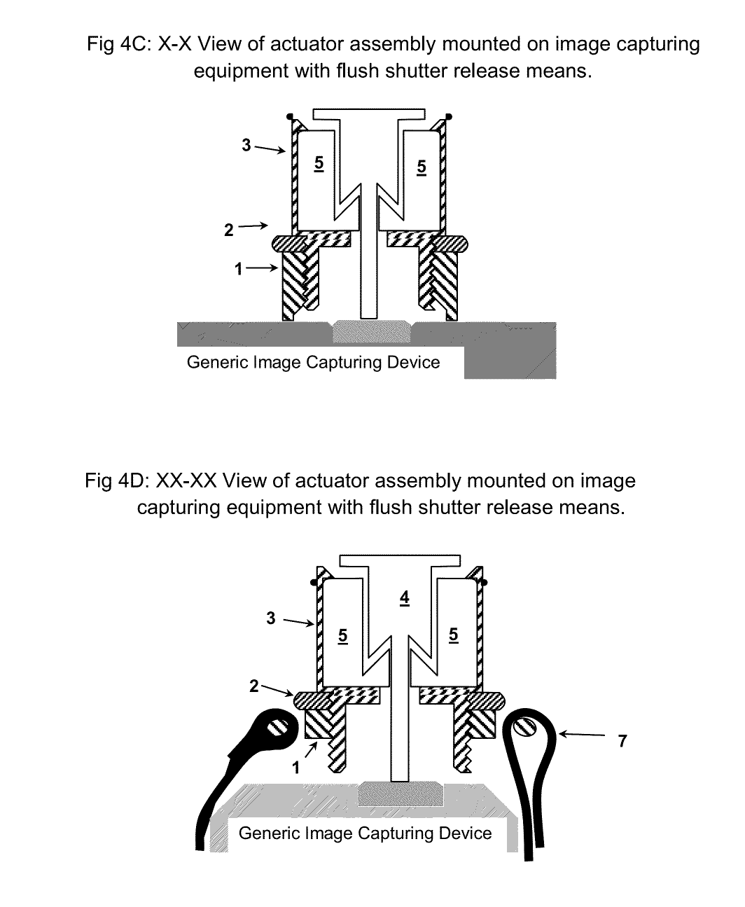

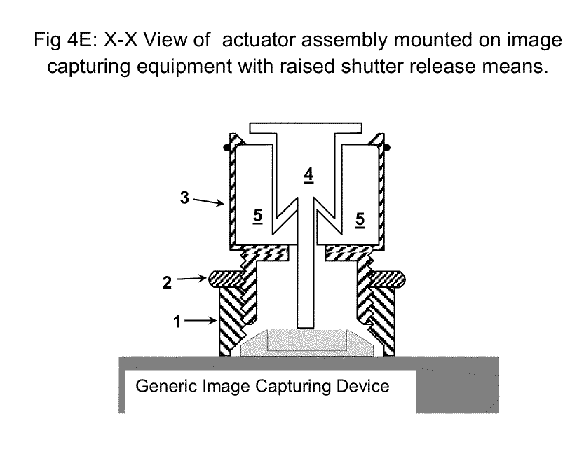

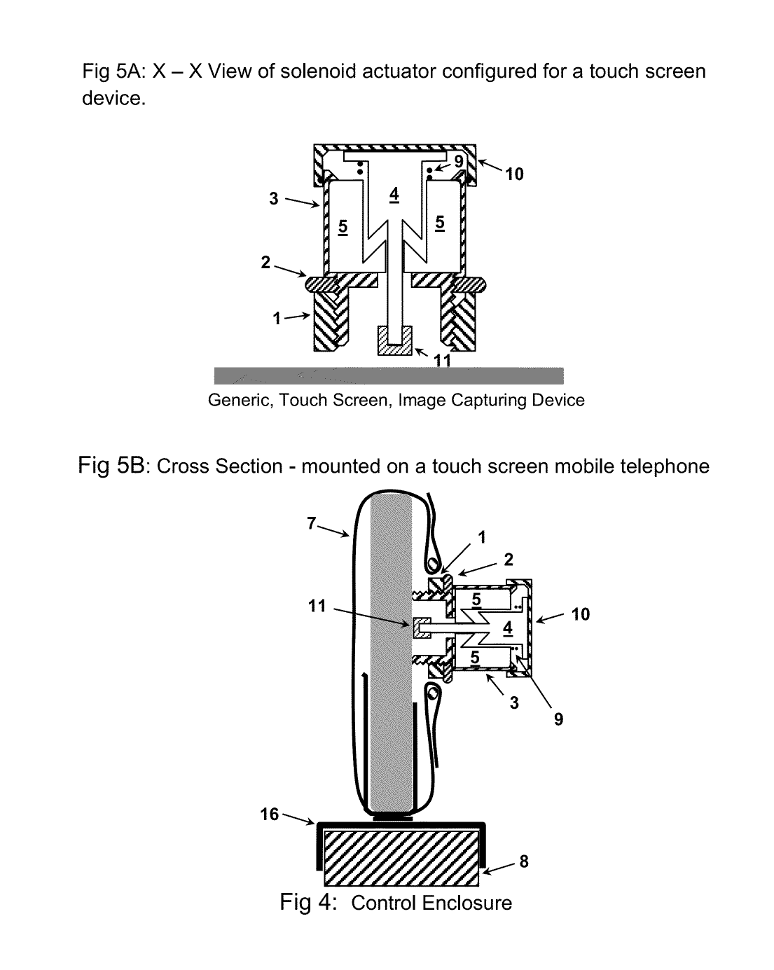

Actuator Assembly with reference to FIG. 4A to 4E inclusive. In this embodiment the actuator assembly consists of five parts. Camera mount, 1, locking ring, 2, solenoid mount, 3, solenoid armature, 4, and the solenoid coil and housing, 5.

The solenoid applies a force to the manual shutter release means of image capturing equipment. It will perform the functions necessary to capture an image that would normally be accomplished by the finger of an operator. The solenoid will have a short length of conductor terminating in a connector to connect it to the conductor issuing from the enclosure.

Camera mount, 1, is an insulating plastic moulding or a combination of mouldings. It forms the female threaded part into which the Solenoid mount, 3, will be screwed. The bottom of the camera mount will be in contact with the case of the image capturing equipment in the area of the shutter release means. This bottom part will be moulded from a semi-hard plastic or a polyurethane elastomer with a Shore rating such that it will partly conform to the shape of the image capturing equipment case and offer a non-slip, non-scuff surface to the same. The camera mount has formed into it, on opposite sides, the facility to fasten each end of the attachment means. The camera mount allows the solenoid mount to be adjusted to take account of different heights (relative to the case of image capturing equipment) of shutter release means, see FIG. 4C and FIG. 4E.

Solenoid Mount, 3, is a plastic moulding designed to enclose the solenoid and lock it in place (the solenoid cage). The locking tabs of the solenoid cage will be designed to be at a specified height above the solenoid case such that they will indicate approximate correct clearance between the solenoid case and the solenoid armature. This is an important function since the force exerted by the solenoid depends on this clearance. There will also be a solenoid armature retaining clip that will lock onto the solenoid cage which is shown in FIG. 5A 10, this may also be used as a clearance setting aid. Additionally, the lower part of the solenoid mount will form the male threaded mating part to the camera mount. The locking ring, 2, serves to lock the solenoid mount at a height specific to a particular piece of image capturing equipment such that the attachment may be removed and re-attached without the need to repeat set-up.

How to use the remote control attachment with a compact digital camera.

To use this present embodiment of the invention the following procedure is envisaged. First, ensure a good source of power is connected to the attachment part and the image capturing equipment is turned on. The image capturing equipment must then be configured to capture images in the desired way. Flash mode, video or still, zoom, resolution, macro etc. must all be set as is usual with this type of equipment. Camera mount and solenoid mount (with locking ring) should be separated. Then with the control enclosure mounted on the attachment means (or otherwise placed such that it can be connected to the actuator assembly), the attachment means is used to position the camera mount. The camera mount should now be secured to the case of the image capturing equipment with the shutter release means in the centre when looking through the circular aperture of the mount. The camera mount (so secured) forms a stable base into which the solenoid mount along with the solenoid, solenoid armature and locking ring is screwed. The solenoid mount is then height adjusted such that the solenoid armature is in contact with the shutter release means and achieves the correct clearance from the solenoid case either by using the retaining clip, 10, or by using the solenoid cage as a height guide, preferably the former. The locking ring is then screwed down onto the camera mount to fix the relative positions. This is the actuator assembly set-up procedure.

The attachment can then be repeatedly detached from and attached to the image capturing equipment without the need to repeat the set-up procedure. Note that portions of both mounts are windowed such that the position of the solenoid armature relative to the shutter release means can be checked while the actuator device is assembled and being attached. To check acceptable height adjustment, it is possible to manually press the solenoid armature, if an image is captured the height as set should be correct. This facility also allows normal, manual use of the image capturing equipment.

The next step is commissioning the attachment part. With the battery compartment cover removed, put the internal 3 way switch to position “C” and press any button on the remote controller. An LED flash will signal completion of commissioning.

Connecting the actuator assembly to the control enclosure using 6, and switching the internal switch to the “F” position is the next step. After a pause the LED will flash twice, in this present embodiment, focus force and capture force will be set by manual adjustment of a potentiometer. The micro-controller will periodically apply a voltage to the solenoid as the potentiometer is being turned. The micro-controller will adjust the PWM duty cycle such that this voltage will be proportional to the potentiometer position. When the image capturing equipment indicates that it has set photo-metric data, pressing button 1 on the remote controller will store duty cycle, voltage and current information for focus force. By continuing to adjust the potentiometer until an image is captured, pressing button 2 will similarly set and store the pulse width, voltage and current for capture force. It is envisioned that in an enhancement to this procedure, forces will be set without the need for manual adjustment. The micro-controller, starting at minimum pulse width (voltage) will gradually increase the voltage to the actuator. When the operator sees or hears confirmation of focus from the image capturing equipment, button 1 on the remote controller will be pressed. Focus force is then set. Capture force will then also be set by pressing button 2. The internal switch should then be set to position “N” and battery compartment cover should be replaced. The device is now capable of basic operation.

If the “Stay Awake” function is required, setting “Stay Awake” is the next step. Many image capturing devices have a low power stand-by mode and a sleep mode. Once in sleep mode the equipment usually requires the ON/OFF button to be pressed to bring it back to active mode. When in low power stand-by mode, dedicated image capturing equipment will usually become fully active as soon as the shutter release means is depressed. Equipment enters sleep mode after a period of inactivity referred to here as sleep delay time. To prevent the image capturing device going into sleep mode the operator normally has to apply pressure to the shutter release means before the sleep delay time has elapsed. On some image capturing devices this sleep delay time can be changed by the operator on others the interval is fixed. The “Stay Awake” function prevents the equipment entering sleep mode. To set “Stay Awake” the operator must ascertain the sleep delay time and using button 4 select an interval equal to or less than the sleep delay time. There will be several different time periods programmed into the attachment micro-controller corresponding to the most popular intervals found on devices examined.

Once the time period is set, “Stay Awake” is activated by pressing button 3. The attachment will indicate “Stay Awake” is active by causing the LED to flash twice when focus force is applied. Initially the “Stay Awake” application of force will be made almost immediately, then subsequently at the set interval. Of course, by using a double press of button 1 on the remote controller, the operator can apply focus force periodically to keep the equipment awake and ready to capture an image.

The invention is now fully set-up and ready to be used.

This detailed description of embodiment 1, together with the referenced figures, is given here to comply with the Patent law requirement for full disclosure of at least one form of the invention.

End of description of Embodiment 1.

### Embodiment 2

This embodiment is specifically designed for image capturing equipment with touch screen control.

Remote Controller.

The remote controller for embodiment 2 may be the same 4 button enclosure as in embodiment 1. However the focus force function may not be required.

Attachment part.

Please refer to FIGS. 5A and 5B. The attachment assembly 1 to 5 detailed in embodiment 1 can be used for embodiment 2 along with the enclosure 8 and attachment means 7. The forces required to operate a touch screen device are much less than those required to operate a push button. It is therefore envisaged that the actuator assembly will be smaller than that in embodiment 1. FIG. 5B shows how the invention will attach to and support a mobile telephone with integrated image capturing equipment. Since the camera mount, 1, is made from insulating material it will have no effect on capacitive touch screen devices and can therefore sit on the screen. For other types of touch screen device where any touch causes a reaction, additional clip-on components will be available to lift the actuator assembly clear of the screen.

The solenoid armature will be fitted with a spring, 9, and the armature retaining clip, 10, will be required. Additionally there will be an integrated cradle and clip-on enclosure bracket, 16, to act as supporting means for the mobile telephone. The mobile telephone cradle part will pivot relative to the enclosure bracket part using a friction jointed pivot and tilt the mobile device such that the angle of the camera relative to the enclosure and hence the surface upon which it is placed can be varied. The angle between the plane of the enclosure and the touch screen of the mobile device will be limited by stops to avoid instability. An actuating pad, 11, will be pushed onto the end of the solenoid armature. This actuating pad will be made from soft conductive plastic such that it will operate all types of touch screen.

The communication and control electronics will be substantially the same as in embodiment 1. Set up and commissioning will be essentially the same as in embodiment 1 except that capture force will be programmed to both button 1 and button 2. Capture force should be properly programmed such that battery life is optimised. With touch screen devices low power stand-by disables the screen functions. To prevent this the “stay awake” function can again be used. In this instance however an image will be captured each time pressure is applied to the screen. However since the equipment storage media is typically substantial this is not a major problem.

The attachment can be used for taking photographs or video simply by setting the equipment to the required mode and positioning the actuating pad over the correct image on the screen.

End of description of Embodiment 2. End of Specification.

What is claimed:

1. The invention disclosed herein is a radio frequency remote control attachment for many types of image capturing equipment that is designed to act directly on existing manual shutter release means. It can be attached to and detached from said equipment without permanent change to the form, fit or function of the equipment.

2. The invention disclosed herein will allow several different and known forces to be applied to the shutter release means of image capturing equipment. This enables all the manual functions which rely on pressure being applied to the shutter release means to be reproduced when and if required. This includes, but is not necessarily limited to, causing photo-metric data to be collected and causing images to be captured. These different forces are achieved by using a micro-controller to vary the duty cycle of a fixed frequency PWM scheme to control a power switch which in turn controls an electro-magnetic actuator. The required duty cycle, voltage and current to achieve a particular force, hence function, are retained in micro-controller memory until they are re-programmed by an operator.

3. The invention disclosed herein can prevent the equipment to which it is attached from entering sleep mode (exiting which often requires power cycling) by periodically applying force to the shutter release means. This period can be set by the operator and keeps the equipment fully active for an extended period such that no manual intervention is required and there is no delay in capturing an image after an extended period of inactivity.
